(19) United States
(12) Patent Application Publication
(10) Pub. No.: US 2006/0221856 A1
(43) Pub. Date: Oct. 5, 2006

(54) System and method for managing master-slave relationships within a network

(75) Inventor: Carlos Quiroz, Helsinki (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/092,189

(22) Filed: Mar. 29, 2005

(51) Int. Cl. H04L 12/28; H04L 12/56

(52) U.S. Cl. 370/254; 370/400

(57) ABSTRACT

A system and method for managing the relationship between master devices and slave devices within a network such as a Bluetooth network. Each time that a master device connects to a slave device, the network topology is updated. This update is transmitted to each slave device, sending the node's properties for each slave device belonging to the network, as well as an update on the priority number given to each slave device. When a master device abruptly exits the network, a slave device with the highest priority configures itself as the master device. The new master device then attempts to connect to the other slave devices using previously-stored information.

### FIELD OF THE INVENTION

The present invention relates generally to master-slave systems operating within a network. More particularly, the present invention relates to master-slave systems within a network where the master device abruptly exits the network.

### BACKGROUND OF THE INVENTION

In recent years, multiplayer games have exploded in popularity around the words. In action/adventure games, sports-based games, and others, several individuals are capable of playing the same game at the same time. Traditionally, this has involved the use of multiple joysticks or game pads which are all connected to a central computer or game unit. More recently, however, users have been able to play such games across larger networks, ranging in size from a single room to the Internet.

One example of a larger network across which such games can be played is a Bluetooth network. Bluetooth is a standard for wireless communications between devices in a personal area network (PAN) using radio frequency for a relatively short range. Bluetooth technology eliminates the need for numerous and inconvenient cable attachments for connecting fixed computers, mobile phones, mobile computers, handheld devices, digital cameras, digital appliances and other devices.

Bluetooth networks can be created in an ad-hoc way to enable applications for multiple users to simultaneously play a single game. This is accomplished through a master-slave system, which is the environment in which a Bluetooth network operates. A Bluetooth network has a master device and several slave devices. The master device controls the traffic flow within the Bluetooth network. From the point of view of the application, a game for example, the master acts as a server relaying the application's state to all the hosts in the network. The master is the only member that knows the topology of the network.

Although the master-slave system provides the ability for the interaction between multiple devices, it possesses significant drawbacks. Due to the nature of Bluetooth networks, any device can disappear at any moment. In the case where a slave device abruptly leaves the network, the master device is still connected to the other slave devices, and the application can adapt to the new topology. If the master device leaves the network at any moment, on the other hand, it takes a significant amount of time to re-establish the network. A principal problem in this situation is the face that the slave do not know the existence of the other slave devices. Therefore, the network essentially disappears when the master device leaves the network. This leads to the termination of the application. In multiplayer games, this is extremely undesirable from the players'0 points of view.

It would therefore be desirable to provide a method and system for reconstructing a network in the situation where the master device leaves the network so that the application can continue to operate.

### SUMMARY OF THE INVENTION

The present invention involves a system and method for addressing the above-identified issues by propagating the network topology to each slave device in the network when the network is constructed. The topology is defined by each node's data, which is comprised primarily of the node's Bluetooth address and service identification for each member of the network. Additionally, a unique priority number is provided to each slave device.

Every time that the master device connects to a slave device, the network topology is updated and transmitted to each slave device. At this time, the node's properties are transmitted to each slave device belonging to the network. An update on the priority number is also provided to each slave device. In a situation where a slave device leaves the network, the topology data is again relayed to the other members of the network.

In a situation where the master device abruptly exits the network, the slave device with the highest priority take the role of the master device and attempts to rebuild the network based on the last topology known to that particular slave device. Assuming that the state of the application-in-use is known, the application continues to run in the new network.

The system and method of the present invention allow a particular application to continue operating in a variety of situations, even in a situation where the master device is removed from the network. This provides a significant advantage to users of multiplayer applications, such as multiplayer video games, where previously such an even could cause major disruptions to the use and enjoyment of the application.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile telephone that can be used in the implementation of the present invention;

FIG. 3 is a schematic representation of the telephone circuitry of the mobile telephone of FIG. 2;

FIG. 4 is a perspective view of a gaming device within which the present invention may be implemented;

FIG. 5 is a representation of a master device and multiple slave devices operating within a network according the principles of the present invention;

FIG. 6 is a flow chart showing the implementation of one embodiment of the present invention;

FIG. 7 is a representation of a software stack used by the present invention; and

FIG. 8 is a diagram showing a message structure that is used according to one embodiment of the present invention.

### DETAILED DESCRIPTION OF THE PREFERRED EMBODIMENTS

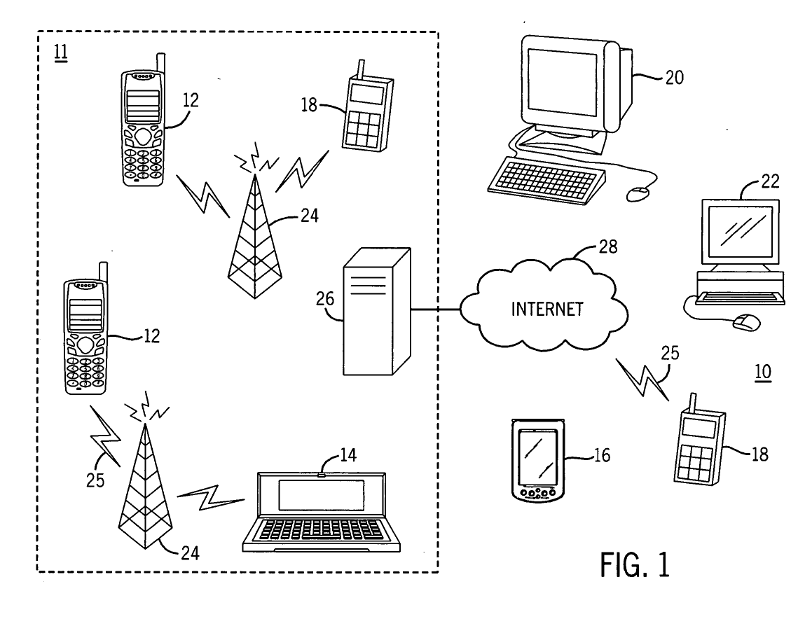

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types. A communication device may communicate using various media including, but not limited to, radio, infrared, laser, cable connection, and the like. One such portable electronic device incorporating a wide variety of features is shown in FIG. 4 and is marketed by Nokia Corporation under the N-GAGE trademark. This particular product serves as both a video gaming device and a portable telephone.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

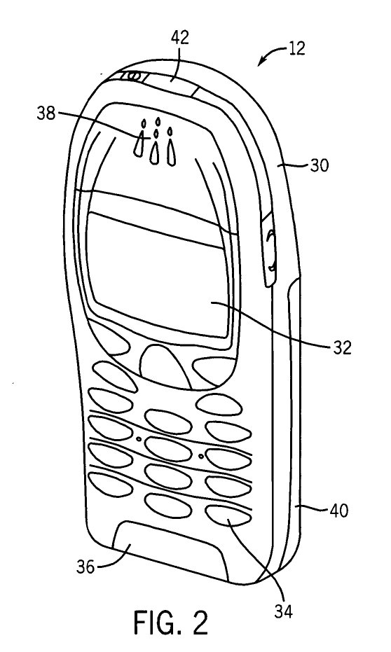

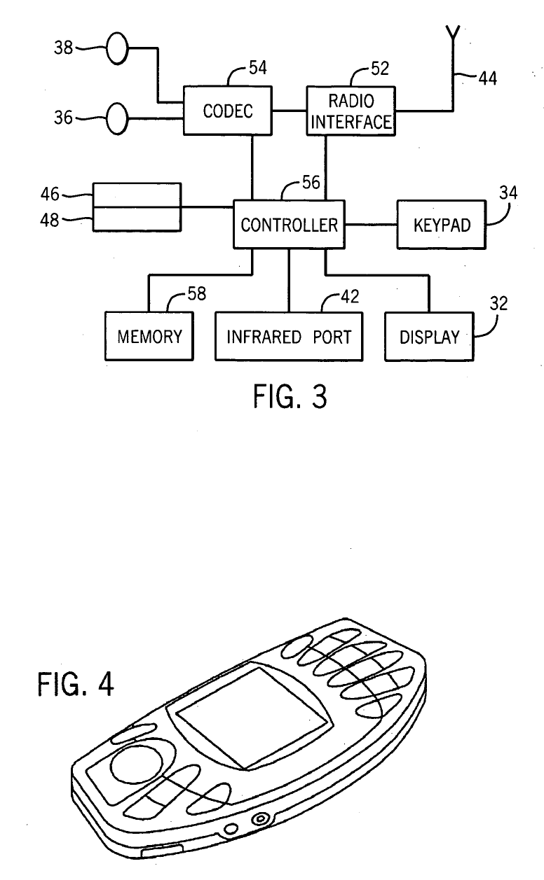

FIGS. 2 and 3 show one representative mobile telephone 12 within which the present invention may be implemented. It should be understood, however, that the present invention is not intended to be limited to one particular type of mobile telephone 12 or other electronic device. For example, the present invention can be incorporated into the N-Gage discussed above. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a universal integrated circuit card (UICC) according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

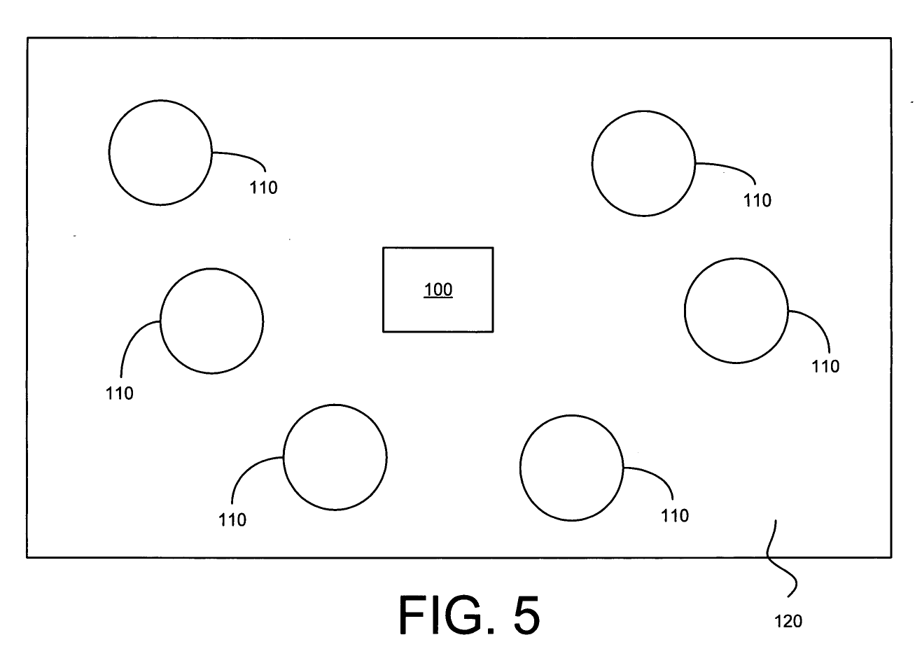

As discussed previously, the present invention addresses the issue of the conventional master-slave arrangement that exists in a conventional Bluetooth multiplayer environment. As shown in FIG. 5, the present invention involves the propagation of the network topology to each of a plurality of slave devices 110 when the larger network 120 is initially constructed. The topology is defined by each node's data, which basically comprises the Bluetooth address and service identifications for each member of the network. Additionally a unique priority number is given to each slave device 110 at upon initiation of the network 120. For example, the slave device 110 that will be the next device in line to become a master device will be assigned a priority of 0, the next device in line will be assigned a priority of 1, etc. In one embodiment of the invention, the master device 100 is responsible for assigning the priority numbers to the respective slave devices 110. Various criteria can be used for assigning priority to the respective slave devices 110. These criteria can relate to hardware capabilities (such as the degree to which each slave device can act as a multipoint master), software capabilities, and others. However and in general, a lower number indicates a higher priority. Therefore, the slave device 110 that assigned a priority level of 0 will be provided with the first opportunity to assume the role of the master device 100.

According to the principles of the present invention, each time that a master device 100 connects to a slave device 110, the network topology is updated. This update is transmitted to each slave device 110, sending the node's properties for each slave device 110 belonging to the network 120, as well as an update on the priority number given to each slave device 110.

In the situation where a slave device 110 leaves the network 120, the topology data for the network 120 is again relayed to the other members of the network 120. In summary, every time that the topology changes, every member of the network 120 obtains an updated view of the network 120, as well as the priority of each slave device 110.

In the event that the master device 100 abruptly leaves the network 120, then the slave device 110 with the highest priority takes the master device's role. This normally corresponds to the slave device 110 have a priority level of 0. In certain situations, the slave device 110 with a 0 priority level will not be available. In such a case, the slave device 110 with the next priority will take over the role of the master device 100 after a defined timeout period. The slave device 110 with the highest priority then attempts to rebuild the network 120 based on the last topology. This slave device 110 will know the topology of the network 120 from the most recent update, and it will therefore be able to attempt to reconnect to the other slave devices 110 in the newly known network 120. After the new network is connected, the procedure discussed above is repeated for the new network.

The system and method of the present invention can be implemented at the Bluetooth protocol level or at the application level. According to one embodiment of the invention, this protocol can be implemented at the application level as shown in FIG. 7. The present invention can also be implemented in current electronic devices supporting Bluetooth technology.

One system for implementing the present invention involves the use of the Java™ application program interfaces (APIs) for Bluetooth technology. This implementation uses the radio frequency communication (RFCOMM) profile and assumes a simple application-level protocol between master devices 100 and slave devices 110. Similar solutions can be implemented on logical link control and adaptation protocol (L2CAP) or using a different application-level protocol. The solution offered by the present invention is also not dependant on the Java™ API for Bluetooth and can be implemented on any application level Bluetooth API such as Symbian, BlueZ, etc.

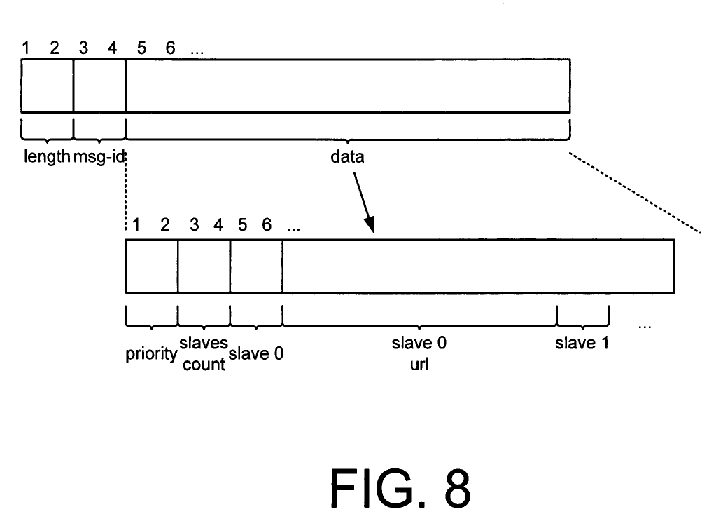

According to one embodiment of the present invention, the application-level protocol is as follows: 2 bytes msg length, 2 bytes msg id, data. These fields are depicted in FIG. 8. As shown in FIG. 8, the first two bytes determine the length of the date. The msg id bytes define the purpose of the message. A particular value agreed to beforehand can be used to update the network topology information. For instance the value 0 can be used to indicate such an update. That message will be followed by the network topology encoded in a proper way. For instance, the network topology could start with the priority number assigned to each specific slave, followed by the count of slaves and the address of each slave. Other values can also be used for application level messages. An example of this type of message is also shown in FIG. 8.

Every time that a slave device 110 contacts or disconnects from the network 120, the master device 100 updates its internal network topology with the latest set of slave devices 110. Afterwards, this data is relayed to each slave device 110 using the message format mentioned above. The data portion of the message contains, first, the priority number for the given slave device 110, followed by a set of URLs for each other clients connected to the network. In one embodiment of the invention, the URLs conform to the format used by the Java JSR-82 specification. Upon receiving the message discussed above, each slave device 110 in the network 120 updates its internal representation of the network topology.

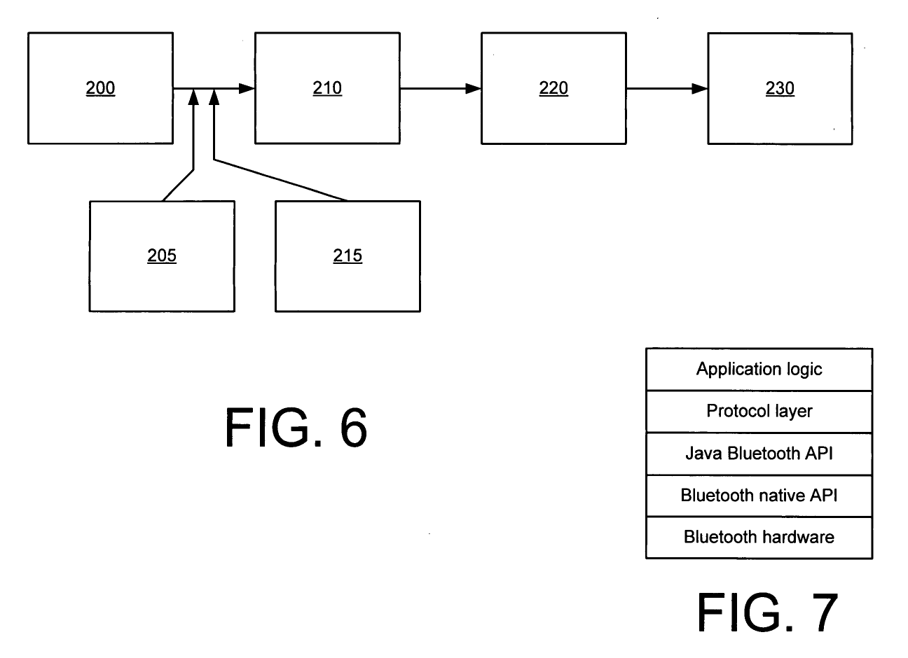

FIG. 6 is a flow chart showing a generic implementation of the present invention. At step 200, a network 120 is established, including a master device 100 and a plurality of slave devices 110. At step 210, the master device 100 abruptly exits the network 120. At this point and at step 220, the slave device 110 with the highest priority configures itself as the master device 100. At step 230, the new master device 100 attempts to connect to the other slave devices 110 using the information previously stored. It is also possible for the provision of the ability to detect multipoint capabilities on the slave devices 110 so that only those capable of being master devices 100 to multiple slave devices 110 can obtain the highest priority.

A specific priority list is maintained in each of the slave devices 110. This is represented at step 205. The list defines the priority of the slave devices 110 of the network 120, so that it is known for each slave device 110 which member of the network 120 is going to act as the new master device 100 in the case of a master device failure. Additionally, the step of updating the internal network topology when a slave device 110 enters or exits the network 120 is represented at step 215.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule-based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of establishing a connection between a plurality of electronic devices, comprising:
determining a priority level associated with each of the plurality of electronic devices;
deciding, based upon the priority level, whether each of the plurality of electronic devices is to operate as a slave device or as a master device, and
for a device that is to operate as a master device, having the master device attempt to connect to each of the plurality of electronic devices that is to operate as a slave device.

2. The method of claim 1, further comprising propagating the master device's network topology to each of the slave devices within the network.

3. The method of claim 1, further comprising:
upon the entrance or exit of a slave device, having the master device update its internal network topology with the latest set of slave devices; and
transmitting the updated internal network topology to each of the slave devices.

4. The method of claim 3, wherein the internal network topology includes the priority level for each of the plurality of slave devices within the network.

5. The method of claim 1, further comprising:
upon the master device exiting the network, having one of the remaining electronic devices with the highest priority level configure itself to serve as a new master device; and
having the new master device attempt to connect to the rest of the plurality of electronic devices.

6. The method of claim 3, further comprising the step of, upon receiving the updated internal network topology, having each of the plurality of slave devices update their own internal representation of the network topology.

7. The method of claim 1, wherein only ones of the plurality of slave devices that are capable of serving as new master devices are capable of obtaining the highest priority level.

8. A computer program product for establishing a connection between a plurality of electronic devices within a network, comprising:
computer code for determining a priority level associated with each of the plurality of electronic devices;
computer code for deciding, based upon the priority level, whether each of the plurality of electronic devices is to operate as a slave device or as a master device, and
computer code for, for a device that is to operate as a master device, having the master device attempt to connect to each of the plurality of electronic devices that is to operate as a slave device.

9. The computer program product of claim 8, further comprising computer code for propagating the master device's network topology to each of the slave devices within the network.

10. The computer program product of claim 8, further comprising:
computer code for, upon the entrance or exit of a slave device, having the master device update its internal network topology with the latest set of slave devices; and
computer code for transmitting the updated internal network topology to the plurality of slave devices.

11. The computer program product of claim 10, wherein the internal network topology includes the priority level for each of the plurality of slave devices.

12. The computer program product of claim 8, further comprising:
computer code for, upon the master device exiting the network, having one of the remaining electronic devices with the highest priority level configure itself to serve as a new master device; and
computer code for having the new master device attempt to connect to the rest of the plurality of electronic devices.

13. The computer program product of claim 10, further comprising computer code for, upon receiving the updated internal network topology, having each of the plurality of slave devices update their own internal representation of the network topology.

14. The computer program product of claim 8, wherein only ones of the plurality of slave devices that are capable of serving as new master devices are capable of obtaining the highest priority level.

15. The computer program product of claim 8, wherein the computer program product establishes the connection between electronic devices at an application level

16. A system for maintaining a relationship among a plurality of electronic devices, comprising:
a master device; and
a plurality of slave devices, each of the plurality of slave devices including a priority level,
wherein a change in an existing network including the master device and the plurality of slave devices, the one of the plurality of slave devices with the highest priority level configures itself to serve as a new master device and attempts to connect to the other devices within the network.

17. The system of claim 16, wherein the master device propagates its network topology to each of the slave devices within the network.

18. The system of claim 16, wherein, upon the entrance or exit of a slave device from the network, the master device updates its internal network topology with the latest set of slave devices and transmits the updated internal network topology to the plurality of slave devices within the network.

19. The system of claim 18, wherein the internal network topology includes the priority level for each of the plurality of slave devices.

20. The system of claim 18, wherein the internal network topology includes a set of URL's for other devices connected to the network.

21. The system of claim 18, wherein, upon receiving the updated internal network topology, each of the plurality of slave devices within the network updates their own internal representation of the network topology.

22. A terminal for establishing a connection with a plurality of remote terminals within a network, comprising:
a processor; and
a memory unit operatively connected to the processor and including:
computer code for determining a priority level in relation to each of the plurality of remote terminals;
computer code for deciding, based upon the priority level, whether the terminal is to operate as a slave device or as a master device, and
computer code for, if the terminal is to operate as the master device, attempting to connect to each of the plurality of remote terminals that are to operate as slave devices.

23. The terminal of claim 22, wherein the memory unit further includes:
computer code for, if a remote terminal is acting as the master device but exits the network, determining whether the terminal has the highest remaining priority level in relation to the remaining remote terminals; and
computer code for, if the terminal has the highest remaining priority level, attempting to connect to each of the plurality of remote terminals so as to serve as the master device.
